(19) United States
(12) Patent Application Publication
(10) Pub. No.: US 2021/0045584 A1
(43) Pub. Date: Feb. 18, 2021

(54) FIVE IN ONE BAR TOOL

(71) Applicant: Nicolae Laurentiu Cardei, Apollo Beach, FL (US)

(72) Inventor: Nicolae Laurentiu Cardei, Apollo Beach, FL (US)

(21) Appl. No.: 16/747,832

(22) Filed: Jan. 21, 2020

Related U.S. Application Data
(60) Provisional application No. 62/887,338, filed on Aug. 15, 2019.

(51) Int. Cl. A47J 43/28; F25D 31/00

(52) U.S. Cl. CPC A47J 43/28; B67B 7/16; F25D 31/002

(57) ABSTRACT

The invention relates to a bar tool that allows the user to easily open bottles and pop top cans, remove speed pourers, scoop ice, and strain beverages

### CROSS-REFERENCE TO RELATED APPLICATION

This application claims priority from U.S. Provisional Patent Application No. 62/887,338, filed Aug. 15, 2019, titled “Five in One Bar Tool” which is hereby incorporated by reference herein for all purposes.

### COPYRIGHT STATEMENT

[symbol]

### BACKGROUND OF THE INVENTION

### 1) Field of the Invention

The present invention relates to implements useful in the food service industry and home use. More particularly, it relates to an implement providing the user a multi-function tool, useful in preparing beverages for patrons of restaurants, bars, and other like establishments, including home use for BBQ's, and entertaining.

### 2) Description of Related Art

Currently, a server or bartender must utilize a number of different tools when preparing beverages for their clients. These tools include bottle openers, can openers, ice scoops, strainers and other devices. These tools may be used to create a single beverage, or they may be used separately but, in most instances, they are typically used in close physical proximity to one another when preparing various beverages. Container openers designed to remove crown caps from bottles or cans, or to assist in the opening of “pull tab” closure mechanism cans, have been incorporated into a variety of different devices. In their simplest form, crown cap bottle openers are a single separate tool. Frequently, bottle openers are incorporated into other devices, such as pocket knives which are configured such that they fold-out of the knife handle. Frequently, bottle openers are attached to the sides of ice chests, or other containers for beverages, to provide ready access to the bottle opener.

Ice scoops also typically are a separate item. Consequently, a person desiring to have both an ice scoop and a bottle opener on his person must use two separate items. Although many situations exist when only an ice scoop is desired or only a bottle opener is desired, there are a large number of applications when it is desirable to have both an ice scoop and a bottle opener available together in the same place, such as in the case of a bar, restaurant, banquet, nightclub setting, or anywhere a beverage is being prepared.

Many bar service applications include the need to strain and chill the beverage which requires at least two tools which the bartender or server must get and use. There is also a need to drain the water from melting ice in order to reduce dilution of the beverage.

Another tool which the bartender or server needs to have access to is the liquor pourer spout remover also known as the speed pourer remover. This device helps the bartender or server remove the speed pourer from the bottle once the bottle is empty so that the speed pourer can be deployed to another bottle.

Therefore, what is needed in the art is a multipurpose tool that a bartender or server can use to prepare beverages for their clients which simplifies the process and minimizes the searching for different tools. Also, by combining the various tools into one multipurpose tool, the bar owner is able to provide the required number of tools to support the bartending or server staff and limit the total number of tools need to be stored, cleaned, and inventoried.

### BRIEF SUMMARY OF THE INVENTION

The current embodiment, in one form, is directed to a multipurpose tool which can be used by bartenders or servers while preparing beverages. The tool provides the bartender or server the ability to be a container opener, funnel, strainer, speed pourer remover, chiller, and ice scoop combination tool. The container opener can provide two functions, either crown cap bottle or pop top can opening.

The invention, in another form, is directed to a multipurpose tool which can be used by bartenders or servers while preparing beverages. The tool provides the bartender or server the ability to scoop ice and hold the scoop with ice in a fixture to allow the bartenders or server the ability to chill the beverage by pouring the beverage through the ice in the scoop and capturing the beverage in a glass after it is poured onto and flows through the ice in the scoop.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral, without specification to an existing sub-label, it is intended to refer to all such multiple similar components.

FIG. 1 is a side view of the multipurpose tool of this embodiment in a stand;

FIG. 2 is a top view of the multipurpose tool of this embodiment in a stand;

FIG. 3 is a view of the of the multipurpose tool of this embodiment in a stand with a collection glass and beverage bottle pouring beverage into the scoop body of the multipurpose tool of this embodiment;

FIG. 4 is angled top view of the multipurpose tool of this embodiment with the speed pourer remover in the side of the ice scoop body of the multipurpose tool.

FIG. 5 is a front view of the multipurpose tool of this embodiment with the speed pourer remover in the side of the ice scoop body of the multipurpose tool.

FIG. 6 is an angled bottom view of the multipurpose tool of this embodiment with the speed pourer remover in the side of the multipurpose tool.

FIG. 7 is a bottom view of an alternative multipurpose tool of this embodiment with the speed pourer remover in the handle of the multipurpose tool.

FIG. 8 is a bottom view of an alternative multipurpose tool of this embodiment with the speed pourer remover in the front of the ice scoop body of the multipurpose tool.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

The prior art is replete with tools to open bottles, open cans, remove speed pours, strain beverages, and scoop ice. Specifically, U.S. patent application 20050060810A1, filed Sep. 24, 2003, U.S. Pat. No. 10,518,402, filed Jan. 20, 2016, Chinese patent 201587843U, Issue/Publication Date: Sep. 22, 2010, Chinese patent 202504917U, Issue/Publication Date: Oct. 31, 2012, Chinese patent 201948660U, Issue/Publication Date: Aug. 31, 2011, Chinese patent 103342326A, Issue/Publication Date: Oct. 9, 2013, Chinese patent 109292707A, Issue/Publication Date: Feb. 1, 2019, Chinese patent CN208843701U, Issue/Publication Date: May 10, 2019, and Chinese patent CN206580525U, Issue/Publication Date: Oct. 24, 2017. All of which are hereby incorporated by reference for all purposes.

The term “load” and “charge”, are defined within the disclosure is meant to mean placing ice within the scoop of the multipurpose tool.

The term “beverage”, as defined within the disclosure is meant to mean liquid, drink, or fluid, and all terms are used interchangeably.

The term “beer bottle opener”, “crown cap opener”, or “bottle opener” is a device to remove a cap from a bottle and all terms are used interchangeably.

The term “can opener”, is a device to remove a top from a pop top or ring closure mechanism from a can and all terms are used interchangeably.

The term “ice”, is ice formed in to any shape, including but not limited to round, cube, crushed, polygons, or rectangular shapes.

The term “pop top” or “ring closure mechanism”, are can closure devices and the terms are used interchangeably.

The term “glass”, is any container that a beverage can be held.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. The multipurpose tool of this embodiment may, however, be embodied in many different forms and should not be construed as being limited to the embodiments set forth herein; rather, these embodiments are provided by way of illustration only and so that this disclosure will be thorough, complete, and fully convey understanding to those skilled in the art.

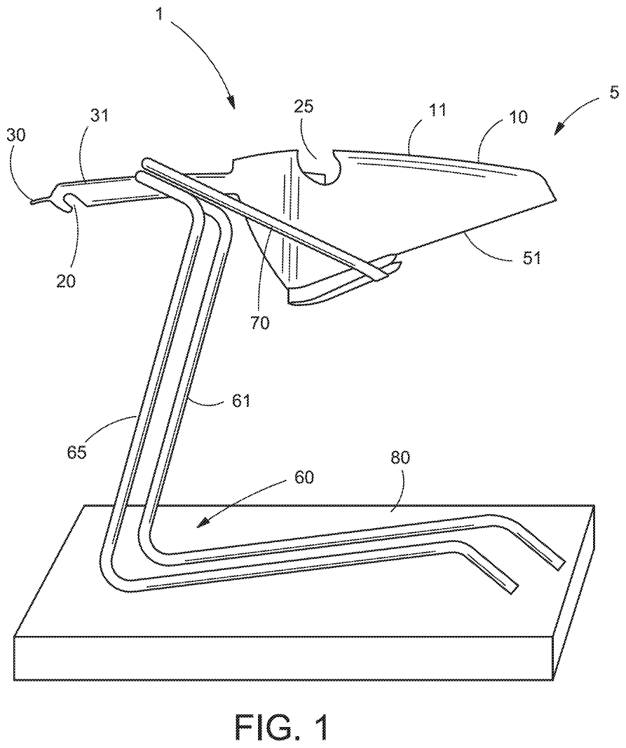

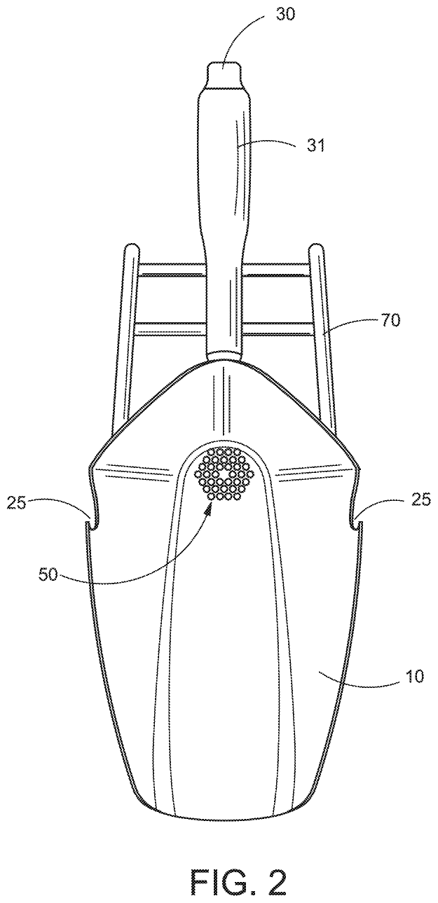

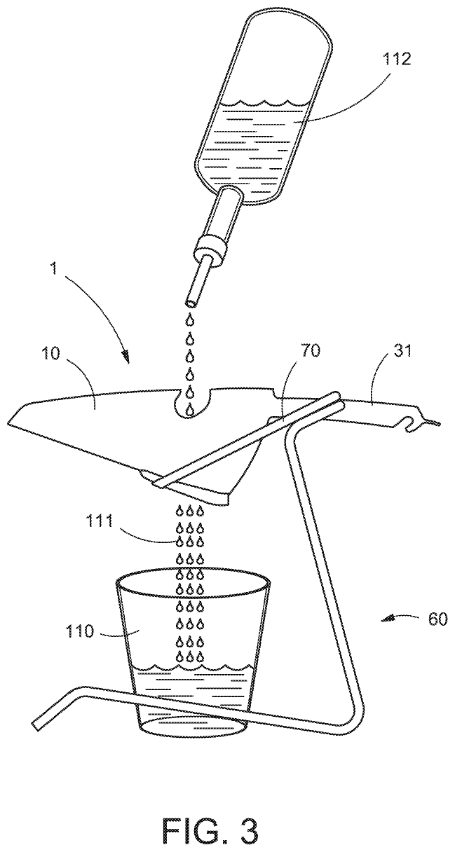

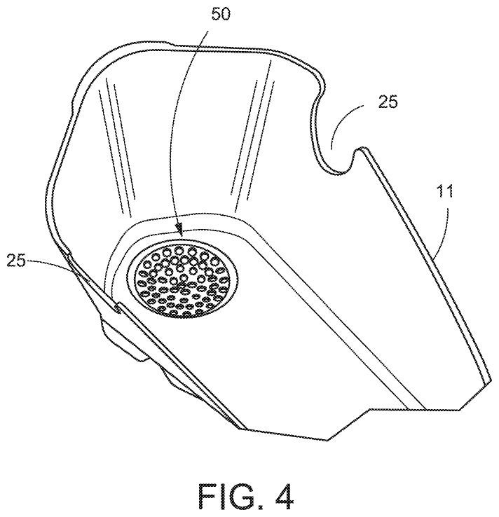

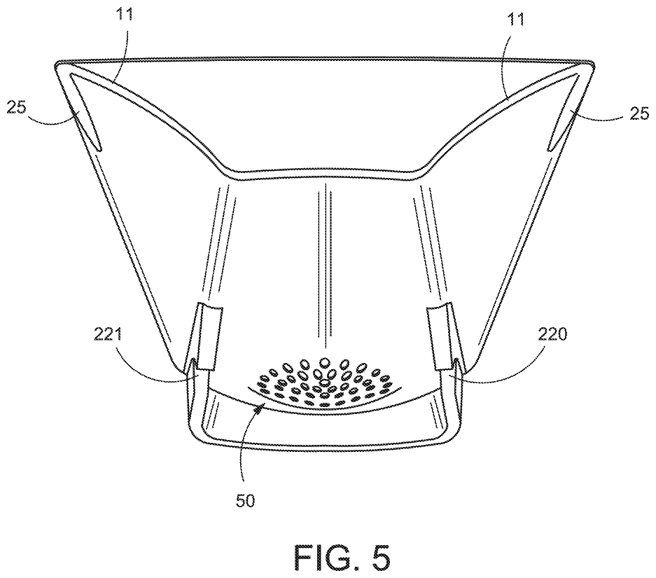

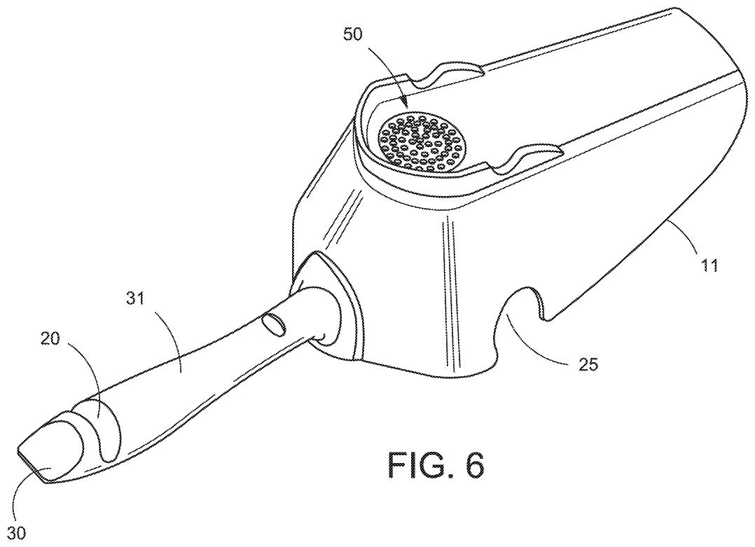

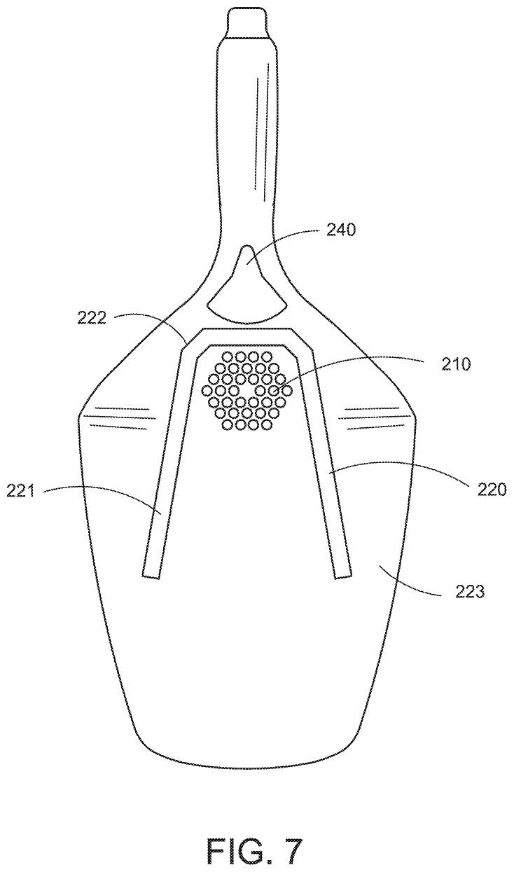

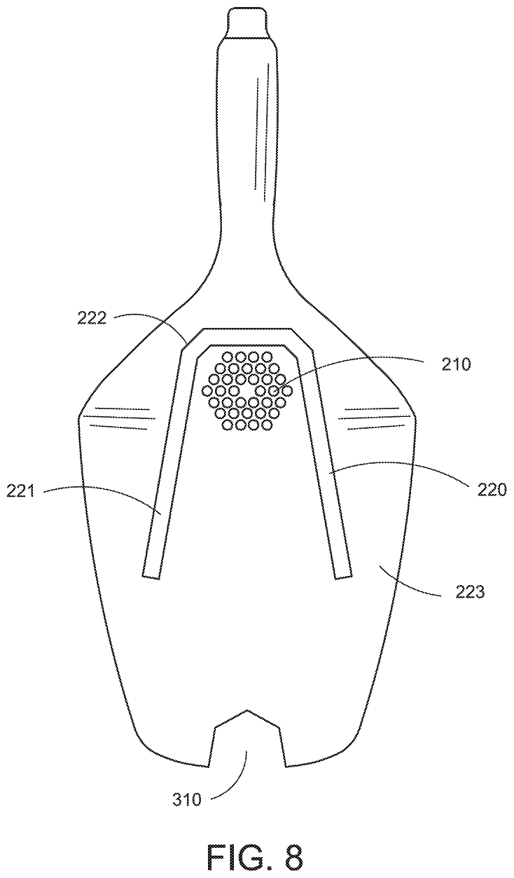

Referring to FIG. 1-8, the current embodiment 1 is a device that combines multiple bar tools in one multipurpose tool 5 which eliminates the need of multiple tools, reduces the storage space required to store several different bar tools by combining all of them in one tool, and provides a safe and sanitary storage of the device in between the use of the multipurpose tool 5 by using the stand 60 to hold the multipurpose tool 5. For example, a traditional crown cap bottle opener and the speed pourer remover are commonly incorporated into a single tool that are carried by bartenders or servers. Many bartenders or servers will carry the tool in their back pocket or in between the bartenders' belt and their body. This creates an unsanitary condition and many clients feel this is not appropriate due to the unsanitary storage of the device. The multipurpose tool 5 of the current embodiment is formed from two primary sections, the first is a handle 31 configured to comfortably be held in a bartenders' or servers' hand when they grip the handle 31; and second is an ice scoop 10 which is configured to scoop ice from an ice tub or bulk holder. Furthermore, the multipurpose tool 5 of the current embodiment combines multiple tools in one including, but not limited to, crown cap opener 20, pop top can opener 30, strainer 50, speed pourer remover 25, ice scoop 10, and funnel 51 formed from the configuration of ice scoop 10, strainer 50 and guided guard 220. By integrating a number of tools into a single easily handled tool, it decreases the probability that the tools will be misplaced, and when located proximal to the ice well area, makes it convenient for scooping ice. The multipurpose toll of this embodiment results in increasing the speed of service and workflow by avoiding misplacing or losing the bar tools during the bar shift and providing all the necessary tools in one device so that the bartender or server can efficiently make the desired beverage for the client. The integral funnel also benefits the bar owner because it makes the transfer of beverage 111 to glass 110 simple and minimizes waste product due to spillage. The current embodiment multipurpose tool 5 also creates a fast and efficient method to chill drinks by pouring the beverage through the ice contained in the scoop 10 and exiting the strainer 50 through holes 210 in the bottom of the ice scoop 10 as shown in FIG. 3. The configuration of ice scoop 10, strainer 50 and guided guard 220, form a natural funnel 51 which simplifies the bartenders' or servers' job when transferring beverage 111. A secondary benefit of the instant invention multipurpose tool 5 is that it also provides a method to open pop top cans so it will protect your fingernails from damage that occurs when opening pop top cans by using your fingernail. The disclosed multipurpose tool 5 and stand 60, comprised of supports or legs 61 and 65, and multipurpose tool holder 70 of the current embodiment and associated method, provide a simple and convenient tool to assist the bartender or server to scoop ice, open a bottle crown cap, open a can with a pop top closure mechanism, remove a speed pourer, strain the water out of the melting ice and/or chill drinks/liquids instantly, and it has its own stand which allows the bartender or server to have a free hand to pour a beverage through the ice in the scoop or to provide a sanitary storage location for the multipurpose tool. The integral funnel 51 can also be used by the bartender to transfer beverage 111 to glass 110 from a bottle 112 or shaker or mixer not shown.

The multipurpose tool 5 of this embodiment has the following features, an ice scoop 10 which incorporates the following into the physical body of the ice scoop 10 a bottle crown cap opener 20 and a can opener 30 which are located on the multipurpose tool's handle 31; the speed pourer remover 25 and the strainer 50, which are located on the multipurpose tool's 5 body; the natural funnel 51, formed from the configuration of the ice scoop 10, the strainer 50 formed from holes 210 and a guided guard 220. The stand 60 which is a separate item specifically designed to hold the multipurpose tool 5 on table or counter top 80.

The multipurpose tool 5 may have alternative configurations so that the speed pourer remover 240 can be installed at either ends of the handle of the multipurpose tool 5, or speed pourer remover 310 can be on the body of the multipurpose tool 5 at the distal end from the handle 31 of the multipurpose tool's 5 ice scoop 10, where the ice enters the multipurpose tool's 5 body ice scoop 10 when scooping ice. When speed pourer remover 310 is located at the distal end of the multipurpose tool's body 5 ice scoop 10, it provides an added benefit of providing additional leverage for the bartender when removing the speed pourer. This simplifies the bartenders job and reduces stress.

Similarly, the associated multipurpose tool 5 of this embodiment can be used in two different methods to transfer a beverage 111 by the bartender or server. The bartender or server can use the multipurpose tool 5 either with the stand 60 or without the stand 60. For example, the bartender or server could use the stand to hold the multipurpose tool and place a glass 110 under the stand so that it is positioned to catch any beverage 111. The bartender or server then pours the beverage 111 into the ice scoop 10 from bottle 112, and beverage 111 exits the strainer 50 holes 210 at the bottom of the ice scoop 10 and fills the glass 110. Glass 110 is placed such that the open face points up towards the strainer 50 in ice scoop 10 which forms the bottom of funnel 51.

Alternatively, the multipurpose tool 5 can be used without the stand 60 to transfer beverage 111. The bartender or server can be hold the multipurpose tool 5 with one hand above the glass 110, while pouring beverage 111 from bottle 112 with the other hand so that the beverage exits the strainer 50 holes 210 at the bottom of the ice scoop 10 and fills the glass 110. One should note that holes 210 of said strainer 50 can be of any shape, including but not limited to round, slot, or polygon shaped.

The multipurpose tool 5 of this embodiment has a feature which helps direct the beverage 111 when it is used to strain or transfer beverages in to a glass 110. The guided guard 220 has legs 221, 222, and 223 which are designed to be funneled shaped to direct the beverage 111 flowing through strainer 50 holes 210 into the glass 110 to reduce unwanted spilling of beverage 111. The guided guard 220 reduces beverage 111 lost thereby saving the bar owner money due to lost beverage 111.

The bartender or server can use the multipurpose tool 5 and stand by utilizing the scoop and stand differently to chill beverage 111. Referring specifically to FIG. 3, the first method is to use the multipurpose tool stand 60 and the multipurpose tool 5 of the current embodiment. The bartender or server first loads or charges the multipurpose tool 5 with ice and places it on the multipurpose tool stand 60, so that it is cradled in multipurpose tool holder 70 such that ice scoop top 11 faces up and strainer 50 faces down. Next, the bartender or server places an empty glass 110 underneath, such that it is in near communication, i.e., not touching, the multipurpose tool 5 strainer 50. Then the bartender or server pours the beverage 111 from bottle 112 into the ice scoop 10. The natural funnel 51 formed from the configuration of the ice scoop 10, strainer 50, formed by holes 210, and guided guard 220, creates a natural path for the beverage 111 to flow through the ice. The strainer 50 and guided guard 220 are in direct communication with each other. The beverage will exit through the strainer 50, which is located on the bottom of the ice scoop 10, and the guided guard 220 will direct the beverage 111 into the glass 110 to reduce unwanted spilling. Alternatively, the bartender or server can hold the multipurpose tool 5 with one hand on top of the glass and pour the beverage 111 with the other hand into ice scoop 10 of the multipurpose tool 5 to fill glass 110 with the chilled beverage 111.

The disclosed device is unique due to the incorporation into multipurpose tool 5 of: a bottle crown cap opener 20 and a pop top can opener 30 on the handle 31 of the device; a guided guard 220 and strainer 50 with holes 210, and a speed pourer remover 25 on the body of the multipurpose tool 5; natural funnel 51; and a stand 60 that allows the tool to be held by the stand 60 to form a convenient method for chilling drinks.

Furthermore, the process of instantly chilling beverages/drinks associated with the multipurpose tool 5 improves the chilling of the beverage 111 without over diluting the beverage 111 with unwanted water from ice. Additionally, the disclosed processes allows the beverage 111 to be strained or funneled through the multipurpose tool 5 ice scoop 10 after either using the stand 60 or by holding the multipurpose tool 5 in the bartenders or servers hand. When the multipurpose tool 5 is charged with ice, the beverage 111 flows over the ice due to the gravitational force and the beverage 111 passes through the ice, exits the multipurpose tool 5 through the guided strainer 50 and holes 210 and the guided guard 220 reduces any splashing of beverage 111. The beverage 111 bathes the ice in the ice scoop 10 and the ice extracts the heat from the beverage 111 thereby instantly chilling the beverage 111. The beverage 111, after passing through multipurpose tool 5, is chilled and collected in the collecting glass 110 that was placed underneath the multipurpose tool's 5 strainer 50.

While this invention has been described with respect to at least one embodiment, the present invention can be further modified within the spirit and scoop of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A multipurpose tool and stand, the multipurpose tool comprising of:
a handle and an ice scoop configured to accept ice in the top of said ice scoop.

2. Said multipurpose tool handle of claim 1 comprising of:
a handle configured to be gripped by a bartenders hand, bottle opener and a pop top can opener.

3. Said multipurpose ice scoop of claim 1 comprising of:
an ice scoop, a strainer, a guided guard, and a speed pour removal tool.

4. Said ice scoop of claim 1, is configured to accept a beverage poured from a bottle into said ice scoop.

5. Said strainer of claim 3, comprising of holes in the bottom of said ice scoop to allow said beverage to exit said ice scoop when said beverage is poured into said ice scoop.

6. Said holes of claim 5, wherein said hole shape is selected from the group consisting of round, slot, and polygon shaped.

7. Said guided guard of claim 3, comprising of guards which funnel said beverage that exits said ice scoop through said strainer to a glass distal from said ice scoops top.

8. Said glass of claim 7, being in near communication with said guided guard which is in communication with said strainer.

9. Said guided guard of claim 7, comprising of three legs and being funnel shaped.

10. Said stand of claim 1, comprising of:
a left side support, a right-side support, a multipurpose tool holder, and said left side support and said right side support configured to sit on a counter top or table.

11. The multipurpose tool handle of claim 1, comprising of:
a speed pourer removal tool, bottle opener, and a pop top can opener.

12. A method of chilling a beverage comprising of:
a. scooping ice into a multipurpose tool;
b. placing said multipurpose tool on a stand;
c. said multipurpose tool ice scoop top facing up when placed in said stand;
d. said strainer facing down when said multipurpose tool is placed in said stand;
e. placing a glass under said multipurpose tool such that the open face is proximal to said strainer in said ice scoop;
f. pouring a beverage into the top of said multipurpose tool ice scoop;
g. said beverage exiting said ice scoop through said strainer in said ice scoop and through said guided guard into said glass.

13. Said ice of claim 12, shape being selected from the group consisting of round, cube, crushed, polygon, and rectangular shapes.

14. A multipurpose tool of claim 12, wherein, the multipurpose tool comprising of:
a handle, an ice scoop, and is configured to accept ice in the top of said ice scoop, a strainer, a speed pourer removal tool, a bottle opener, and a pop top can opener.

15. A multipurpose tool of claim 12, wherein said stand has a left leg, a right leg, and a holder configured to support the multipurpose tool on a counter top such that the top of said multipurpose tool ice scoop faces up and said strainer of said multipurpose tool ice scoop faces down.

16. A method of chilling a beverage comprising of:
a. scooping ice into a multipurpose tool;
b. holding said multipurpose tool in one hand;
c. said multipurpose tool ice scoop top facing up when held in said hand;
d. said strainer facing down when said multipurpose tool is held in said hand;
e. placing a glass under said multipurpose tool such that the open face is proximal to said strainer in said ice scoop;
f. pouring a beverage into the top of said multipurpose tool ice scoop;
g. said beverage exiting said ice scoop through said strainer in said ice scoop and through said guided guard into said glass.

17. A multipurpose tool of claim 16, wherein the multipurpose tool comprising of:
a handle, an ice scoop and is configured to accept ice in the top of said ice scoop, a strainer, a speed pourer removal tool, a bottle opener, and a pop top can opener.

18. Said ice of claim 16, shape being selected from the group consisting of round, cube, crushed, polygons and rectangular shapes.

19. A method of transferring a beverage comprising of:
a. placing said multipurpose tool on a stand;
b. said multipurpose tool ice scoop top facing up when placed in said stand;
c. said strainer facing down when said multipurpose tool is placed in said stand;
d. placing a glass under said multipurpose tool such that the open face is proximal to said strainer in said ice scoop;
e. pouring a beverage into the top of said multipurpose tool ice scoop;
f. said beverage exiting said ice scoop through said strainer in said ice scoop and through said guided guard into said glass.

20. A method of transferring a beverage comprising of:
a. holding said multipurpose tool in one hand;
b. said multipurpose tool ice scoop top facing up when held in said hand;
c. said strainer facing down when said multipurpose tool is held in said hand;
d. placing a glass under said multipurpose tool such that the open face is proximal to said strainer in said ice scoop;
e. pouring a beverage into the top of said multipurpose tool ice scoop;
f. said beverage exiting said ice scoop through said strainer in said ice scoop and through said guided guard into said glass.
